(19) United States
(12) Patent Application Publication
(10) Pub. No.: US 2007/0008028 A1
(43) Pub. Date: Jan. 11, 2007

(54) Over boosting prevention circuit

(75) Inventor: Shuhei Kawai, Gunma (JP)

Correspondence Address: MORRISON & FOERSTER LLP, 1650 TYSONS BOULEVARD, SUITE 300, MCLEAN, VA, 22102, US

(73) Assignee: SANYO ELECTRIC CO., LTD., Osaka (JP)

(21) Appl. No.: 11/475,258

(22) Filed: Jun. 27, 2006

(30) Foreign Application Priority Data
Jun. 28, 2005 (JP) 2005-188472

(51) Int. Cl. G05F 1/10

(52) U.S. Cl. 327/536

(57) ABSTRACT

In a over boosting prevention circuit that prevents over boosting of a voltage boosting circuit, ripples caused in the voltage boosting circuit are removed to prevent malfunctioning. The over boosting prevention circuit controls the output voltage Vout (<0V) of a charge pump circuit so that a difference (Vdd−Vout) between the power supply voltage Vdd and the output voltage Vout of the charge pump circuit does not exceed a predetermined value VMAX. That is, the charge pump circuit performs boosting operation when Vdd−Vout<VMAX, and stops the boosting operation when Vdd−Vout>VMAX. Influence of the ripples caused in the charge pump circuit is removed because the reference voltage Vref to an operational amplifier is determined relative to a ground voltage Vss.

### CROSS-REFERENCE OF THE INVENTION

This application is based on Japanese Patent Application No. 2005-188472, the content of which is incorporated herein by reference in its entirety.

### BACKGROUND OF THE INVENTION

1. Field of the Invention

This invention relates to an over boosting prevention circuit that prevents over boosting of a voltage boosting circuit that generates an output voltage negative to a ground voltage.

2. Description of the Related Art

A charge pump circuit has been known as a kind of voltage boosting circuit that multiplies a power supply voltage. The charge pump circuit is widely used as a power supply circuit for a portable electronic device, for example. A typical charge pump circuit is made of a plurality of switching devices connected in series, and boosts the power supply voltage by providing a boosting clock to each connecting node between the switching devices through a capacitor to transfer electric charges through the switching devices.

As a result of the boosting, however, a high voltage is applied to transistors used as the switching devices in the charge pump circuit and transistors in a circuit that is provided with an output voltage Vout from the charge pump circuit.

For example, when the output voltage Vout is applied to a gate G of a MOS transistor and the ground voltage Vss is applied to a source S of the MOS transistor, the high voltage Vout is applied between the gate G and the source S, as shown in FIG. 6A. Or, when the output voltage Vout is applied to a drain D of a MOS transistor and the ground voltage Vss is applied to a source S of the MOS transistor, the high voltage Vout is applied between the source S and the drain D, as shown in FIG. 6B.

Therefore, a high withstand voltage structure has been adopted as a device structure for such MOS transistors. However, the MOS transistors of the high withstand voltage structure have a problem of low current drive capability because they require a thick gate insulation film and low impurity concentration source-drain diffusion layers.

In order to improve the current drive capability by reducing the withstand voltage of the MOS transistors, a circuit limiting the output voltage Vout of the charge pump circuit has been devised. For example, if the power supply voltage Vdd of 4V is doubled to 8V, MOS transistors that withstand 8V are required. Instead, if the output voltage Vout of the charge pump circuit is limited to 5.5V, 5V type MOS transistors can be used, making it possible to improve the current drive capability and to reduce a die size.

FIG. 7 is a circuit diagram of such an over boosting prevention circuit. An output voltage Vout (>0V) of a positive voltage boosting charge pump circuit 50 is divided by resistors R1 and R2 to generate a voltage V0. A supply of a boosting clock Φ to the charge pump circuit 50 is controlled by an output of a comparator 51 that compares the voltage V0 with a reference voltage Vref that is determined relative to the ground voltage Vss (0 V). That is, when V0<Vref, the charge pump circuit 50 performs boosting operation since the output of the comparator 51 is at an H (high) level and the boosting clock Φ is provided to the charge pump circuit 50. When V0 rises to become V0>Vref, the output of the comparator 51 becomes an L (low) level and the supply of the boosting clock Φ to the charge pump circuit 50 stops. As a result, the charge pump circuit 50 stops the boosting operation. Here,
V0=Vout×R2/(R1+R2).

That is, the charge pump circuit 50 stops the boosting operation when Vout>Vref×(R1+R2)/R2.

On the other hand, an output voltage Vout of a negative voltage boosting charge pump circuit is a negative voltage below the ground voltage Vss (0V). For example, in the case of a circuit that generates Vout=−0.5 Vdd based on the power supply voltage Vdd, Vout varies in response to Vdd, as shown in FIG. 8. That is, an absolute value of Vout increases as Vdd increases. Looking from the ground voltage Vss, Vout increases in a negative direction as Vdd increases in a positive direction.

A maximum voltage applied to transistors used as switching devices in the charge pump circuit or to transistors in a circuit provided with the output voltage Vout of the charge pump circuit is Vdd−Vout (=1.5 Vdd), and is not represented by an absolute value of Vout from the ground voltage Vss like in the case of the positive voltage boosting charge pump circuit. For example, when Vdd is applied to a gate G of a MOS transistor and Vout is applied to its drain D, a voltage Vdd−Vout (=1.5 Vdd) is applied between the gate and the drain, as shown in FIG. 9.

Further description on the technologies described above may be found in Japanese Patent Application Publication Nos. 2001-112239 and 2001-231249.

Therefore, in order to provide an over boosting prevention circuit for the negative voltage boosting charge pump circuit using the circuit described above, the reference voltage inputted to the comparator has to be a reference voltage that is a function of the output voltage Vout of the charge pump circuit, and it is not Vref that is determined relative to the ground voltage Vss. That is, the reference voltage is Vref+Vout.

However, when an output current of the charge pump circuit increases, the reference voltage (Vref+Vout) fluctuates significantly under the influence of ripples caused in the charge pump circuit. As a result, the over boosting prevention circuit malfunctions.

Also, there arises another problem that another reference voltage Vref has to be generated separately when the reference voltage Vref that is determined relative to Vss is required in addition to the reference voltage (Vref+Vout) used in the over boosting prevention circuit, because a single reference voltage can not be used as two different reference voltages.

### SUMMARY OF THE INVENTION

This invention offers a new over boosting prevention circuit that can use a reference voltage Vref that is determined relative to the ground voltage Vss.

This invention provides an over boosting prevention circuit that prevents over boosting of a voltage boosting circuit generating in response to a boosting clock an output voltage that is negative to the ground voltage, including a first and a second resistors that divide a difference between a power supply voltage and the output voltage to generate a first voltage, a third resistor and a first transistors connected in series between the power supply voltage and the output voltage, an operational amplifier outputting a control voltage to a gate of the first transistor so that a second voltage at a connecting node between the third resistor and the first transistor is made equal to the first voltage, a second transistor to a gate of which the control voltage outputted from the operational amplifier is applied, a fourth resistor having one end connected to the ground voltage, a current mirror circuit providing the fourth resistor with a current equal to a current flowing through the second transistor and a clock control circuit that compares a third voltage generated at another end of the fourth resistor with a reference voltage that is determined relative to the ground voltage and controls supply of the boosting clock to the voltage boosting circuit according to a result of the comparison.

This invention also provides an over boosting prevention circuit that prevents over boosting of a voltage boosting circuit generating in response to a boosting clock an output voltage that is negative to the ground voltage, including a first transistor and a first resistor connected in series between the power supply voltage and the ground voltage, an operational amplifier outputting a control voltage to a gate of the first transistor so that a first voltage at a connecting node between the first transistor and the first resistor is made equal to a reference voltage that is determined relative to the ground voltage, a second resistor to one end of which the output voltage is applied, a current mirror circuit providing the second resistor with a current equal to a current flowing through the first resistor to generate a second voltage at another end of the second resistor, a third and a fourth resistors that divide a difference between the power supply voltage and the output voltage to generate a third voltage and a clock control circuit that compares the second voltage with the third voltage and controls supply of the boosting clock to the voltage boosting circuit according to a result of the comparison.

This invention also provides an over boosting prevention circuit that prevents over boosting of a voltage boosting circuit generating in response to a boosting clock an output voltage that is negative to the ground voltage, including a first transistor and a first resistor connected in series between the power supply voltage and the ground voltage to generate a first voltage at a connecting node between them, a second transistor and a second resistor connected in series between the power supply voltage and the output voltage to generate a second voltage at a connecting node between them, an operational amplifier outputting a control voltage to a gate of the first transistor and a gate of the second transistor so that the first voltage is made equal to a reference voltage that is determined relative to the ground voltage, a third and fourth resistors that divide a difference between the power supply voltage and the output voltage to generate a third voltage and a clock control circuit that compares the second voltage with the third voltage and controls supply of the boosting clock to the voltage boosting circuit according to a result of the comparison.

### BRIEF DESCRIPTION OF THE DRAWINGS

FIG. 1 is a circuit diagram of an over boosting prevention circuit according to a first embodiment of this invention.

FIGS. 2A and 2B are circuit diagrams of a charge pump circuit.

FIG. 3 is a timing chart showing operation of the charge pump circuit.

FIG. 4 is a circuit diagram of an over boosting prevention circuit according to a second embodiment of this invention.

FIG. 5 is a circuit diagram of an over boosting prevention circuit according to a third embodiment of this invention.

FIGS. 6A and 6B show biasing status of MOS transistors.

FIG. 7 is a circuit diagram of an over boosting prevention circuit according to a conventional art.

FIG. 8 shows an output voltage of a negative voltage boosting charge pump circuit.

FIG. 9 shows biasing status of a MOS transistor.

FIG. 10 is a circuit diagram of an over boosting prevention circuit according to a reference example.

### DETAILED DESCRIPTION OF THE INVENTION

An over boosting prevention circuit according to a reference example is described before describing embodiments of this invention. FIG. 10 is a circuit diagram of such an over boosting prevention circuit. Resistors R1 and R2 are connected in series between an output voltage Vout (<0V) of a negative voltage boosting charge pump circuit 60 and a power supply voltage Vdd to generate a voltage V0′ at a connecting node between the resistors R1 and R2. A supply of a boosting clock Φ to the charge pump circuit 60 is controlled by an output of a comparator 61 that compares the voltage V0′ with a reference voltage (Vref+Vout) that is a function of the output voltage Vout.

That is, when V0′>Vref+Vout, the charge pump circuit 60 performs boosting operation since the output of the comparator 61 is at an H (high) level and the boosting clock Φ is provided to the charge pump circuit 60.

When V0′<Vref+Vout by the boosting operation of the charge pump circuit 60, the output of the comparator 61 becomes an L (low) level and the supply of the boosting clock Φ to the charge pump circuit 60 stops. For example, when Vref=1.2V, in order to set that the output of the comparator 61 is inverted when Vdd−Vout=5.5V,

$$\begin{matrix}V {0}^{′} = \frac{( V dd - V out ) R 2}{R 1 + R 2} + V out = \frac{5.5 R 2}{R 1 + R 2} + V out & [ Equation 1 ] \\ V {0}^{′} = V out + V ref = V out + 1.2 V & [ Equation 2 ]\end{matrix}$$

From Equation 1 and Equation 2,

$$\frac{R 2}{R 1} = \frac{1.2}{4.3} \qquad [ Equation 3 ]$$

A ratio of R2 to R1 should be set to satisfy Equation 3.

When the reference voltage (Vref+Vout) that is a function of the output voltage Vout is used, however, the reference voltage (Vref+Vout) fluctuates significantly under the influence of ripples caused in the charge pump circuit 60. As a result, the over boosting prevention circuit malfunctions.

In order to solve the problem addressed above, the embodiments of this invention provide over boosting prevention circuits that remove the influence of ripples caused in the charge pump circuit by using a reference voltage Vref that is determined relative to the ground voltage Vss and is not a function of Vout.

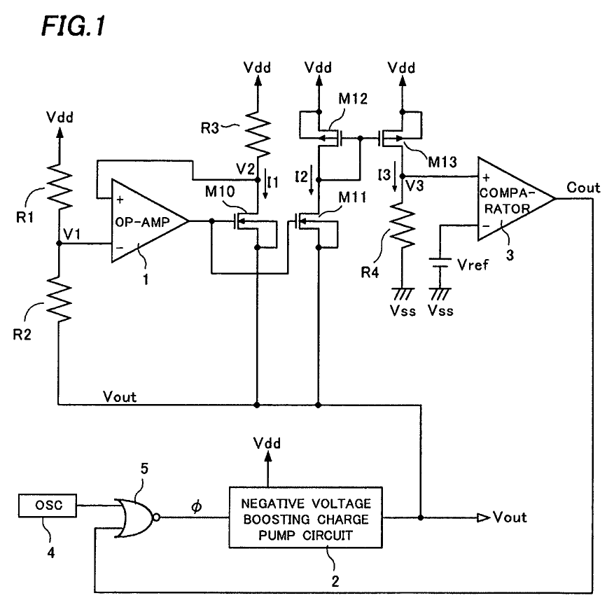

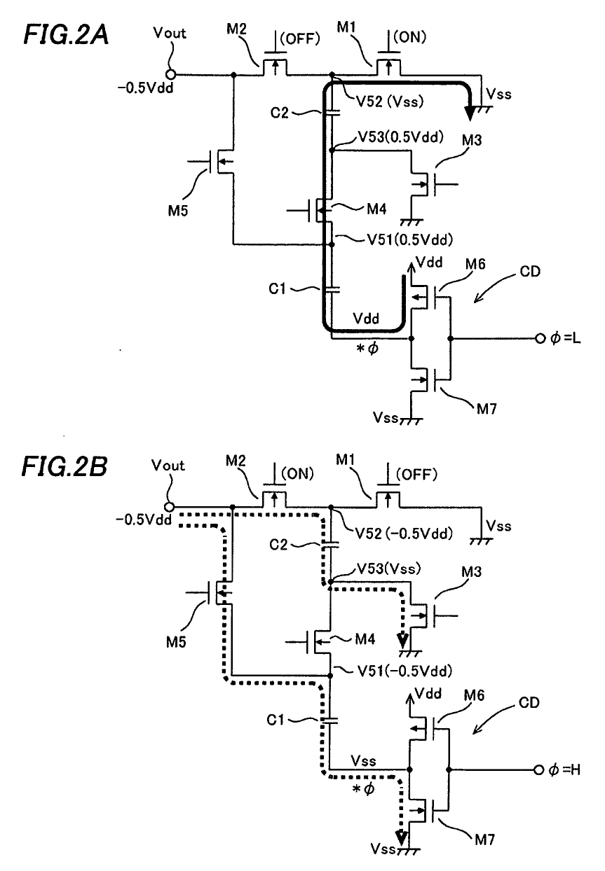

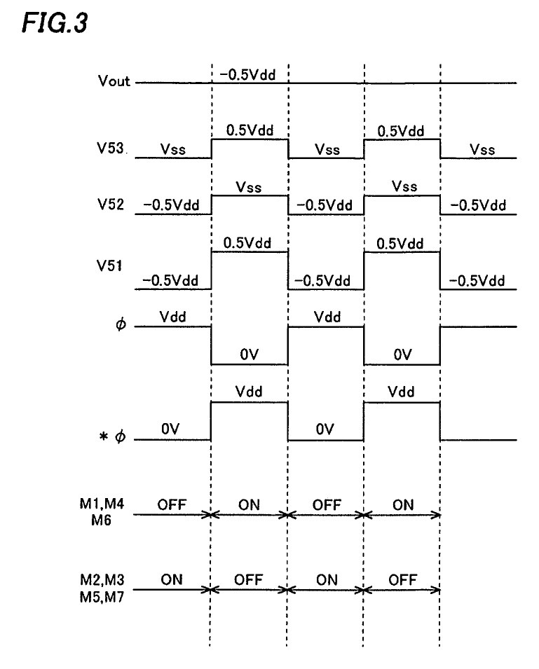

Next, an over boosting prevention circuit according to a first embodiment of this invention will be described in detail, referring to FIGS. 1-3. FIG. 1 is a circuit diagram of the over boosting prevention circuit, FIGS. 2A and 2B are circuit diagrams of a negative voltage boosting charge pump circuit 2 shown in FIG. 1, and FIG. 3 is a timing chart showing an operation of the negative voltage boosting charge pump circuit 2.

The over boosting prevention circuit controls the output voltage Vout (<0V) of the charge pump circuit 2 so that a difference (Vdd−Vout) between the power supply voltage Vdd and the output voltage Vout of the charge pump circuit 2 does not exceed a predetermined value VMAX. That is, the charge pump circuit 2 performs boosting operation when Vdd−Vout<VMAX, and the charge pump circuit 2 stops the boosting operation when Vdd−Vout>VMAX.

As shown in FIG. 1, a first resistor R1 and a second resistor R2 are connected in series between the power supply voltage Vdd and the output voltage Vout of the charge pump circuit 2. The power supply voltage Vdd is applied to the first resistor R1 and the output voltage Vout is applied to the second resistor R2. A first voltage V1 at a connecting node between the first resistor R1 and the second resistor R2 is expressed by the following equation:

$$V 1 = \frac{R 1 Vout + R 2 Vdd}{R 1 + R 2} \qquad [ Equation 4 ]$$

where R1 represents a resistance of the first resistor R1, and R2 represents a resistance of the second resistor R2.

Assuming R1=R2 for simplicity, V1 is expressed by the following equation:

$$V 1 = \frac{Vdd + Vout}{2} \qquad [ Equation 5 ]$$

A third resistor R3 and a first MOS transistor M10 of N-channel type are connected in series between the power supply voltage Vdd and the output voltage Vout. The power supply voltage Vdd is applied to the third resistor R3, while the output voltage Vout is applied to a source of the first MOS transistor M10.

The first voltage V1 is inputted to a negative input terminal (−) of an operational amplifier 1, while a second voltage V2 that is a voltage at a connecting node between the third resistor R3 and the first MOS transistor M10 is inputted to a positive input terminal (+) of the operational amplifier 1. The operational amplifier 1 outputs a control voltage to a gate of the first MOS transistor M10 so that the second voltage V2 becomes equal to the first voltage V1.

That is, the following equation holds because of an imaginary short of the operational amplifier 1:
V1=V2 [Equation 6]

The control voltage outputted from the operational amplifier 1 is applied to a gate of a second MOS transistor M11 of N-channel type. The output voltage Vout is applied to a source of the second MOS transistor M11. A drain of the second MOS transistor M11 is connected with a drain of a third MOS transistor M12. The power supply voltage Vdd is applied to a source of the third MOS transistor M12. A gate of the third MOS transistor M12 is connected with a gate of a fourth MOS transistor M13 to form a current mirror circuit. One end of a fourth resistor R4 is connected with a drain of the fourth MOS transistor M13, and another end of the fourth resistor R4 is connected with the ground. A current I1 flowing through the first MOS transistor M10 is expressed by the following equation:

$$I 1 = \frac{Vdd - V 2}{R 3} \qquad [ Equation 7 ]$$

where R3 represents a resistance of the third resistor R3.

By plugging Equation 5 and Equation 6 into Equation 7, the current I1 is expressed by the following equation:

$$I 1 = \frac{Vdd - Vout}{2 R 3} \qquad [ Equation 8 ]$$

An equation I1=I2=I3 holds because of folding by the current mirror circuit, where I2 represents a current flowing through the second MOS transistor M11 and I3 represents a current flowing through the fourth resistor R4.

Therefore, a third voltage V3 at a connecting node between the fourth MOS transistor M13 and the fourth resistor R4 is given by the following equation:

$$V 3 = I 3 R 4 = I 1 R 4 = \frac{( Vdd - Vout ) R 4}{2 R 3} \qquad [ Equation 9 ]$$

where R4 represents a resistance of the fourth resistor R4.

The third voltage V3 is inputted to a positive input terminal (+) of a comparator 3. And a reference voltage Vref that is determined relative to the ground voltage Vss is inputted to a negative input terminal (−) of the comparator 3. A result of the comparison between the third voltage V3 and the reference voltage Vref makes an output Cout of the comparator 3. The output Cout of the comparator 3 is inputted to a NOR circuit 5. A clock outputted from an oscillator 4 is also inputted to the NOR circuit 5.

Because Cout is at the L level when V3<Vref, the clock outputted from the oscillator 4 goes through the NOR circuit 5 and inputted to the charge pump circuit 2 as a boosting clock Φ. In practical applications, various clocks are generated based on the boosting clock Φ by a control circuit, which is not shown in the figure, to control turning on and off of switching MOS transistors in the charge pump circuit 2. The charge pump circuit 2 performs the boosting operation with them.

When V3 is raised to become V3>Vref by the boosting operation of the charge pump circuit 2, Cout changes from the L level to the H level. Since the output of the NOR circuit 5 is fixed at the L level as a result, the boosting clock Φ is no longer provided to the charge pump circuit 2, and the boosting operation of the charge pump circuit 2 is stopped.

Thus, the over boosting is prevented by judging whether V3>Vref. By plugging Equation 9 into the judging criteria, following judging formula is obtained:

$$Vdd - Vout ≻ \frac{2 VrefR 3}{R 4} \qquad [ Formula 10 ]$$

For example, when Vref=1.2V, R3=110 kΩ and R4=48 kΩ, the judging formula becomes Vdd−Vout>5.5V, meaning that the boosting operation can be stopped when the difference between the power supply voltage Vdd and the output voltage Vout of the charge pump circuit 2 becomes 5.5V.

That is, with the over boosting prevention circuit according to the first embodiment, when R1=R2, the boosting operation of the charge pump circuit 2 can be stopped at a desired value of Vdd−Vout by setting values of R3 and R4 to satisfy Formula 10. The value of Vdd−Vout can be set as well when R1≠R2, by following similar calculation steps. Because the reference voltage Vref that is determined relative to the ground voltage Vss is used, the influence of ripples appearing in the output voltage Vout of the charge pump circuit 2 can be removed to prevent malfunctioning of the circuit.

This embodiment can be applied to any charge pump circuit, as long as the charge pump circuit performs voltage boosting in response to the boosting clock and generates a negative output voltage Vout (<0V). Vout may be −0.5 Vdd or −Vdd, for example. Next, a charge pump circuit that outputs −0.5 Vdd as the output voltage Vout will be explained as an example of the charge pump circuit 2, referring to FIGS. 2A, 2B and 3.

FIGS. 2A and 2B are circuit diagrams of the charge pump circuit 2. FIG. 2A shows a status of the charge pump circuit 2 when the boosting clock Φ inputted to a clock driver CD is at an L level (Vss), while FIG. 2B shows a status of the charge pump circuit 2 when the boosting clock Φ is at an H level (Vdd). The ground voltage Vss (0V) is applied to a source of a first switching MOS transistor M1. A drain of the first switching MOS transistor M1 is connected to a source of a second switching MOS transistor M2. The first switching MOS transistor M1 and the second switching MOS transistor M2 serve as charge transfer devices.

Both the first switching MOS transistor M1 and the second switching MOS transistor M2 are of N-channel type. The reason is to obtain voltages to turn on and off the first switching MOS transistor M1 and the second switching MOS transistor M2 from voltages available within the circuit. The power supply voltage Vdd may be applied to gates of the first switching MOS transistor M1 and the second switching MOS transistor M2 to turn them on, and an output voltage Vout (=−0.5 Vdd) of the circuit may be applied to the gates to turn them off.

An output of the clock driver CD is connected to a terminal of a first capacitor C1. The clock driver CD is a CMOS inverter composed of a P-channel type MOS transistor M6 and an N-channel type MOS transistor M7 connected in series between the power supply voltage Vdd and the ground voltage Vss. The boosting clock Φ is inputted to the clock driver CD and is inverted by the clock driver CD. A reverse clock *Φ that is the output of the clock driver CD is applied to the terminal of the first capacitor C1.

Alternatively, a delayed clock Φ′ generated by delaying the boosting clock Φ may be applied to a gate of the N-channel type MOS transistor M7 while the boosting clock Φ is applied to a gate of the P-channel type MOS transistor M6 in order to reduce a through-current flowing through the clock driver CD. A terminal of a second capacitor C2 is connected to a connecting node between the first switching MOS transistor M1 and the second switching MOS transistor M2. A third switching MOS transistor M3 is connected between another terminal of the second capacitor C2 and the ground voltage Vss (0V).

A fourth switching MOS transistor M4 is connected between another terminal of the first capacitor C1 and the another terminal of the second capacitor C2. A fifth switching MOS transistor M5 is connected between the another terminal of the first capacitor C1 and an output terminal that is a drain of the second switching MOS transistor M2. The output voltage Vout (=−0.5 Vdd) of the circuit is obtained from the drain of the second switching MOS transistor M2.

The third switching MOS transistor M3 and the fifth switching MOS transistor M5 are of N-channel type. The reason is to obtain voltages to turn on and off the third switching MOS transistor M3 and the fifth switching MOS transistor M5 from voltages available within the circuit, as in the case of the first switching MOS transistor M1 and the second switching MOS transistor M2. That is, the power supply voltage Vdd may be applied to gates of the third switching MOS transistor M3 and the fifth switching MOS transistor M5 to turn them on, and the output voltage Vout (=−0.5 Vdd) of the circuit may be applied to the gates to turn them off.

Although the fourth switching MOS transistor M4 may be either of P-channel type or N-channel type, N-channel type is preferable to reduce a patterning area. The power supply voltage Vdd may be applied to a gate of the fourth switching MOS transistor M4 to turn it on and the output voltage Vout (=−0.5 Vdd) of the circuit may be applied to the gate to turn it off, when the fourth switching MOS transistor M4 is of N-channel type. The ground voltage Vss or the output voltage Vout may be applied to the gate of the fourth switching MOS transistor M4 to turn it on and the power supply voltage Vdd may be applied to the gate to turn it off, when the fourth switching MOS transistor M4 is of P-channel type.

It is assumed that a capacitance of the first capacitor C1 and a capacitance of the second capacitor C2 are equal to each other. Turning on and off of the first switching MOS transistor M1, the second switching MOS transistor M2, the third switching MOS transistor M3, the fourth switching MOS transistor M4 and the fifth switching MOS transistor M5 is controlled by controlling their gate voltages with a control circuit that is not shown in the figure according to a voltage level of the boosting clock Φ, as will be described below.

Next, boosting operation of the charge pump circuit 2 will be explained referring to FIGS. 2A and 2B and FIG. 3. FIG. 3 is a timing chart showing the operation of this charge pump circuit 2 in a stationary state. First, the operation of the charge pump circuit 2 when the boosting clock Φ is at the L level will be described (Refer to FIG. 2A and FIG. 3.). Since the P-channel type MOS transistor M6 of the clock driver CD is turned on and the N-channel type MOS transistor M7 is turned off, the reverse clock *Φ is at the H level (Vdd). The first switching MOS transistor M1 and the fourth switching MOS transistor M4 are turned on while the second switching MOS transistor M2, the third switching MOS transistor M3 and the fifth switching MOS transistor M5 are turned off.

As a result, the P-channel type MOS transistor M6 of the clock driver CD, the first capacitor C1, the fourth switching MOS transistor M4, the second capacitor C2 and the first switching MOS transistor M1 are connected in series between the power supply voltage Vdd and the ground voltage Vss as indicated with a solid bold line in FIG. 2A, and the first capacitor C1 and the second capacitor C2 are charged.

The terminal of the first capacitor C1 is charged to Vdd, a voltage V51 at the another terminal of the first capacitor C1 is charged to +0.5 Vdd and a voltage V53 at the another terminal of the second capacitor C2 is also charged to +0.5 Vdd.

Next, the operation of the circuit when the boosting clock Φ is at the H level will be described (Refer to FIG. 2B and FIG. 3.). Since the N-channel type MOS transistor M7 of the clock driver CD is turned on and the P-channel type MOS transistor M6 is turned off, the reverse clock *Φ becomes to the L level (Vss). The first switching MOS transistor M1 and the fourth switching MOS transistor M4 are turned off while the second switching MOS transistor M2, the third switching MOS transistor M3 and the fifth switching MOS transistor M5 are turned on.

As a result, −0.5 Vdd is provided to the output terminal through two paths indicated with dashed bold lines in FIG. 2B. Electric charges in the second capacitor C2 are discharged to provide the output terminal with −0.5 Vdd through one of the paths that runs from the ground voltage Vss to the output terminal through the third switching MOS transistor M3, the second capacitor C2 and the second switching MOS transistor M2. This is because the voltage V53 at the another terminal of the second capacitor C2 has been charged to +0.5 Vdd when the boosting clock Φ is at the L level and a voltage V52 at the terminal of the second capacitor C2 is pulled down from Vss (0V) to −0.5 Vdd by capacitive coupling through the second capacitor C2 when the voltage V53 varies from +0.5 Vdd to Vss by turning-on of the third switching MOS transistor M3.

Charges in the first capacitor C1 is discharged to provide the output terminal with −0.5 Vdd through another of the paths that runs from the ground Vss to the output terminal through the N-channel type MOS transistor M7 of the clock driver CD, the first capacitor C1 and the fifth switching MOS transistor M5.

This is because the voltage V51 at the another terminal of the first capacitor C1 has been charged to +0.5 Vdd when the boosting clock Φ is at the L level and the voltage V51 at the another terminal of the first capacitor C1 is pulled down from +0.5 Vdd to −0.5 Vdd by capacitive coupling through the first capacitor C1 when the voltage at the terminal of the first capacitor C1 varies from Vdd to Vss by turning-on of the N-channel type MOS transistor M7 at the change in the boosting clock Φ to the H level. With respect to the second switching MOS transistor M2 and the fifth switching MOS transistor M5 at that time, because Vdd is applied to their gates and Vout=−0.5 Vdd is applied to their drains, a voltage Vdd−Vout=1.5 Vdd is applied between the gate and the drain of each of the switching MOS transistors M2 and M5.

The output voltage Vout of−0.5 Vdd that is the power supply voltage Vdd multiplied by −0.5 is obtained by alternately repeating the operation when the boosting clock Φ is at the L level and the operation when the boosting clock Φ is at the H level. As described above, when V3 is raised to become V3>Vref, the output Cout of the comparator 3 changes from the L level to the H level and the boosting clock Φ, that is the output of the NOR circuit 5, is fixed at the L level. As a result, the boosting operation of the charge pump circuit 2 is stopped. Thus, the voltage Vdd−Vout is limited.

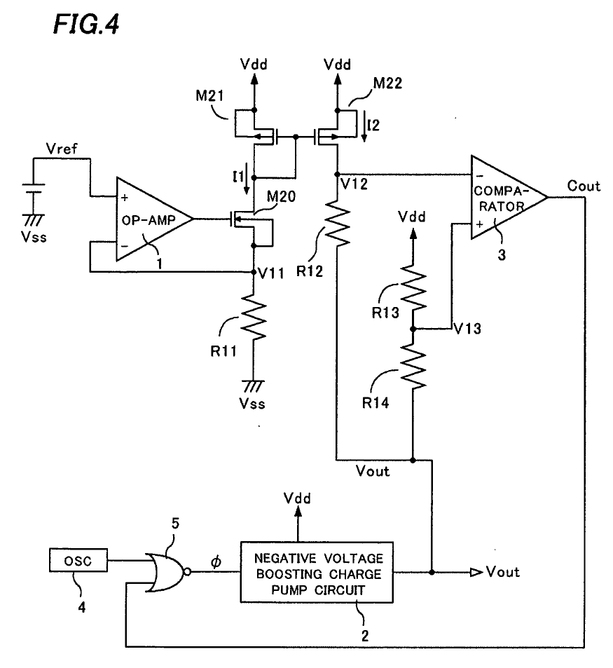

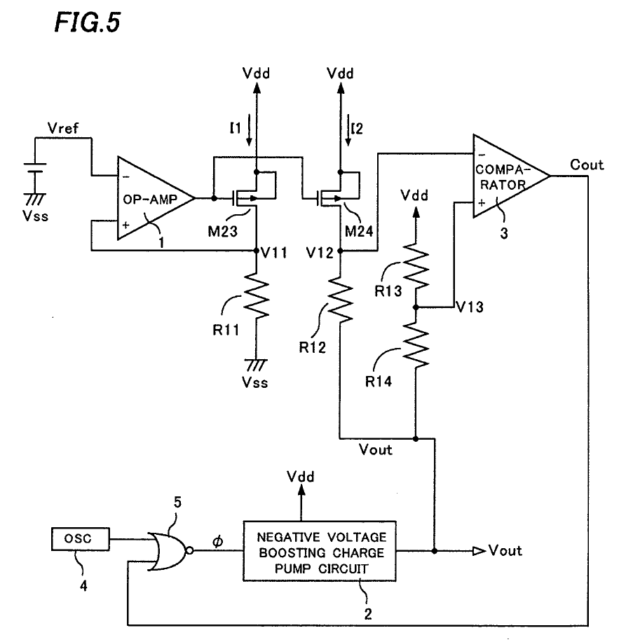

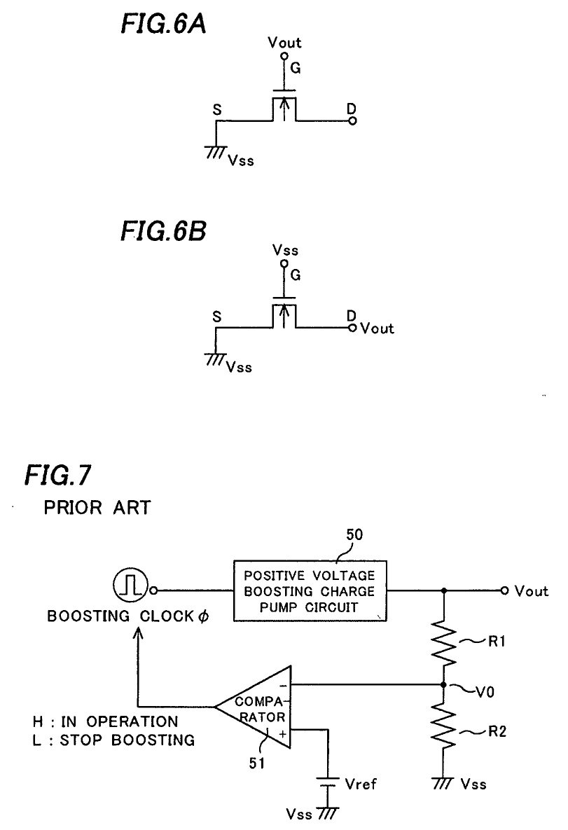

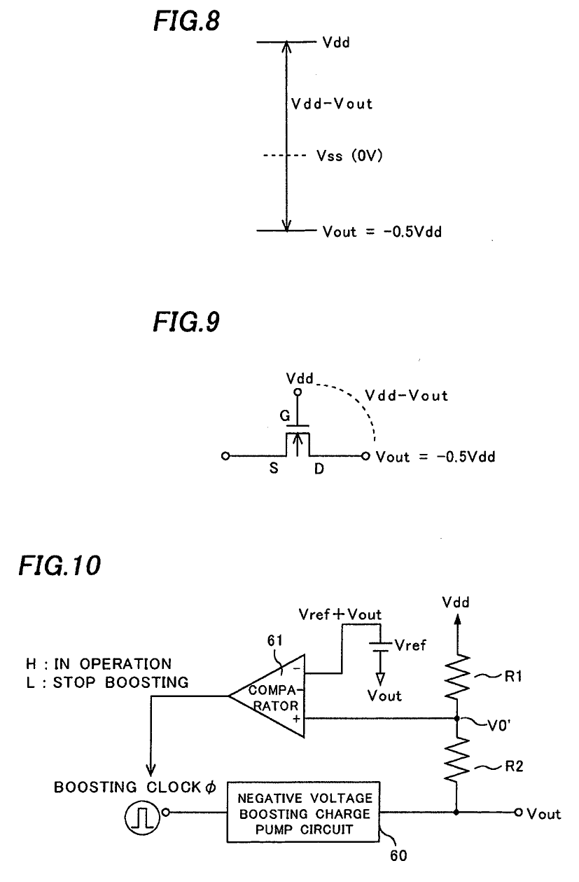

Next, an over boosting prevention circuit according to a second embodiment of this invention will be described in detail, referring to FIG. 4.

A reference voltage Vref that is determined relative to the ground voltage Vss is applied to a positive input terminal (+) of an operational amplifier 1. A first MOS transistor M20 is connected in series with a first resistor R11 that is connected to the ground. A first voltage V11 at a connecting node between the first MOS transistor M20 and the first resistor R11 is inputted to a negative input terminal (−) of the operational amplifier 1. The operational amplifier 1 outputs a control voltage to a gate of the first MOS transistor M20 of N-channel type so that the first voltage V11 is made equal to the first reference voltage Vref.

A drain of the first MOS transistor M20 is connected with a drain of a second MOS transistor M21 of P-channel type. The power supply voltage Vdd is applied to a source of the second MOS transistor M21. A gate of the second MOS transistor M21 is connected with a gate of a third MOS transistor M22 to form a current mirror circuit. One end of a third resistor R12 is connected with a drain of the third MOS transistor M22, and another end of the second resistor R12 is connected with an output voltage Vout of a charge pump circuit 2.

A current I1 flowing through the first MOS transistor M20 and the first resistor R11 is expressed by the following equation:

$$I 1 = \frac{Vref}{R 11} \qquad [ Equation 11 ]$$

where R11 represents a resistance of the first resistor R11.

A current I2 flowing through the second resistor R12 is made equal to the current I1 because of the current mirror circuit. Therefore, a second voltage V12 at a connecting node between the third MOS transistor M22 and the second resistor R12 is given by the following equation:

$$V 12 = I 2 R 12 + Vout = I 1 R 12 + Vout = \frac{VrefR 12}{R 11} + Vout \qquad [ Equation 12 ]$$

where R12 represents a resistance of the second resistor R12.

On the other hand, a third resistor R13 and a fourth resistor R14 are connected in series between the power supply voltage Vdd and the output voltage Vout of the charge pump circuit 2. The power supply voltage Vdd is applied to the third resistor R13 and the output voltage Vout is applied to the fourth resistor R14. A third voltage V13 at a connecting node between the third resistor R13 and the fourth resistor R14 is expressed by the following equation:

$$V 13 = \frac{( Vdd - Vout ) R 14}{R 13 + R 14} + Vout \qquad [ Equation 13 ]$$

where R13 represents a resistance of the third resistor R13, while R14 represents a resistance of the fourth resistor R14.

The second voltage V12 is inputted to a negative input terminal (−) of a comparator 3 and the third voltage V13 is inputted to a positive input terminal (+) of the comparator 3. Because an output Cout of the comparator 3 is at the L level when V13<V12, the clock outputted from the oscillator 4 goes through a NOR circuit 5 and inputted to the charge pump circuit 2 as a boosting clock Φ. As a result, the charge pump circuit 2 performs a boosting operation. When V12 is lowered to become V13>V12 by the boosting operation of the charge pump circuit 2, Cout changes from the L level to the H level. Since the output of the NOR circuit 5 is fixed at the L level as a result, the boosting clock Φ is no longer provided to the charge pump circuit 2, and the boosting operation of the charge pump circuit 2 is stopped.

Thus, the over boosting is prevented by judging whether V13>V12.

Following formula is obtained by plugging Equation 12 and Equation 13 into the judging criteria:

$$Vdd - Vout ≻ \frac{R 12 ( R 13 + R 14 ) Vref}{R 11 R 14} \qquad [ Formula 14 ]$$

The boosting operation can be stopped when the difference between the power supply voltage Vdd and the output voltage Vout of the charge pump circuit 2 becomes a predetermined value (a value represented by a right side of Formula 14). This embodiment can be applied to any charge pump circuit, as long as the charge pump circuit performs voltage boosting in response to the boosting clock and generates a negative output voltage Vout (<0V), as in the first embodiment. Vout may be −0.5 Vdd or −Vdd, for example.

Next, an over boosting prevention circuit according to a third embodiment of this invention will be described in detail, referring to FIG. 5. In the second embodiment, the output of the operational amplifier 1 is applied to the gate of the first MOS transistor M20 of N-channel type, and the current I1 flowing through the first MOS transistor M20 is transferred to the next stage by the current mirror circuit using the second and third MOS transistors M21 and M22 of P-channel type. In the third embodiment, on the other hand, an output of an operational amplifier 1 is applied to a pair of P-channel type MOS transistors to drive a current mirror circuit.

That is, a first MOS transistor M23 of P-channel type and a first resistor R11 are connected in series between the power supply voltage Vdd and the ground voltage Vss, as shown in FIG. 5. The power supply voltage Vdd is applied to a source of the first MOS transistor M23 and the first resistor R11 is connected to the ground.

A reference voltage Vref that is determined relative to the ground voltage Vss is applied to a negative input terminal (−) of the operational amplifier 1. A first voltage V11 at a connecting node between the first MOS transistor M23 and the first resistor R11 is inputted to a positive input terminal (+) of the operational amplifier 1. The operational amplifier 1 outputs a control voltage to a gate of the first MOS transistor M23 so that the first voltage V11 is made equal to the reference voltage Vref.

A second MOS transistor M24 of P-channel type and a second resistors R12 are connected in series between the power supply voltage Vdd and an output voltage Vout of a charge pump circuit 2. The power supply voltage Vdd is applied to a source of the second MOS transistor M24 and the output voltage Vout is applied to the second resistor R12. A second voltage V12 is generated at a connecting node between the second MOS transistor M24 and the second resistor R12. The output of the operational amplifier 1 is applied to a gate of the second MOS transistor M24.

Since the first MOS transistor M23 and the second MOS transistor M24 form the current mirror circuit, a current I1 flowing through the first MOS transistor M23 and the first resistor R11 is set to be equal to a current I2 flowing through the second MOS transistor M24 and the second resistor R12. That is, I1=I2.

The rest of the circuit structure is exactly the same as that in the second embodiment. Thus Equation 11, Equation 12, Equation 13 and Formula 14 hold as well in this embodiment as in the second embodiment. Therefore, the boosting operation can be stopped when the difference between the power supply voltage Vdd and the output voltage Vout of the charge pump circuit 2 becomes the predetermined value (the value represented by the right side of Formula 14). This embodiment can be applied to any charge pump circuit, as long as the charge pump circuit performs voltage boosting in response to the boosting clock and generates a negative output voltage Vout (<0V), as in the first embodiment. Vout may be −0.5 Vdd or −Vdd, for example.

Ripples caused in the boosting circuit can be removed to prevent the over boosting prevention circuit from malfunctioning, because the reference voltage Vref that is determined relative to the ground voltage Vss can be used in the over boosting prevention circuit according to the embodiments of this invention. Therefore, the over boosting prevention circuit of this invention is suitable for a voltage boosting circuit that outputs a large current.

Also, the reference voltage can be shared with other circuit which uses the reference voltage Vref that is determined relative to the ground voltage Vss when necessary.

What is claimed is:

1. An over boosting prevention circuit for a voltage boosting circuit that generates in response to a boosting clock an output voltage that is negative with respect to a ground voltage, comprising:
a first resistor and a second resistor that divide a potential difference between a power supply voltage and the output voltage to generate a first voltage;
a third resistor and a first transistor connected in series between the power supply voltage and the output voltage;
an operational amplifier that outputs a control voltage to a gate of the first transistor so that a second voltage that is a voltage at a connecting node between the third resistor and the first transistor is equal to the first voltage;
a second transistor receiving the control voltage from the operational amplifier at a gate thereof;
a fourth resistor connected to the ground voltage;
a current mirror circuit that provides the fourth resistor with a current equal to a current flowing through the second transistor; and
a clock control circuit that controls a supply of the boosting clock to the voltage boosting circuit based on a result of a comparison between a third voltage that is generated at a connecting node between the fourth resistor and the current mirror circuit and a reference voltage that does not depend on the output voltage.

2. The over boosting prevention circuit of claim 1, wherein the clock control circuit comprises a comparator that compares the third voltage with the reference voltage, a clock generation circuit that generates the boosting clock and a gating circuit that cuts off the boosting clock generated in the clock generation circuit in response to an output of the comparator.

3. The over boosting prevention circuit of claim 1, wherein a resistance of the first resistor is equal to a resistance of the second resistor.

4. An over boosting prevention circuit for a voltage boosting circuit that generates in response to a boosting clock an output voltage that is negative with respect to a ground voltage, comprising:
a first transistor and a first resistor connected in series between a power supply voltage and the ground voltage;
an operational amplifier that outputs a control voltage to a gate of the first transistor so that a first voltage that is a voltage at a connecting node between the first transistor and the first resistor is equal to a reference voltage that does no depend on the output voltage;
a second resistor receiving the output voltage;
a current mirror circuit providing the second resistor with a current equal to a current flowing through the first resistor to generate a second voltage that is a voltage at a connecting node between the second resistor and the current mirror circuit;
a third resistor and a fourth resistor that divide a potential difference between the power supply voltage and the output voltage to generate a third voltage; and
a clock control circuit that controls a supply of the boosting clock to the voltage boosting circuit based on a result of a comparison between the second voltage and the third voltage.

5. The over boosting prevention circuit of claim 4, wherein the clock control circuit comprises a comparator that compares the second voltage with the third voltage, a clock generation circuit that generates the boosting clock and a gating circuit that cuts off the boosting clock generated in the clock generation circuit in response to an output of the comparator.

6. An over boosting prevention circuit for a voltage boosting circuit that generates in response to a boosting clock an output voltage that is negative with respect to a ground voltage, comprising:
a first transistor and a first resistor connected in series between a power supply voltage and the ground voltage and generating a first voltage at a connecting node between the first transistor and the first resistor;
a second transistor and a second resistor connected in series between the power supply voltage and the output voltage and generating a second voltage at a connecting node between the second transistor and the second resistor;
an operational amplifier that outputs a control voltage to a gate of the first transistor and a gate of the second transistor so that the first voltage is equal to a reference voltage that does not depend on the output voltage;
a third resistor and a fourth resistor that divide a potential difference between the power supply voltage and the output voltage to generate a third voltage; and
a clock control circuit that controls a supply of the boosting clock to the voltage boosting circuit based on a result of a comparison between the second voltage and the third voltage.

7. The over boosting prevention circuit of claim 6, wherein the clock control circuit comprises a comparator that compares the second voltage with the third voltage, a clock generation circuit that generates the boosting clock and a gating circuit that cuts off the boosting clock generated in the clock generation circuit in response to an output of the comparator.
